(19) United States
(12) Patent Application Publication
(10) Pub. No.: US 2025/0059412 A1
(43) Pub. Date: Feb. 20, 2025

(54) HOT-MELT ADHESIVE COMPOSITIONS COMPRISING NON-VIRGIN POLYMERIC MATERIAL

(71) Applicant: IFS Industries, Inc., Reading, PA (US)

(72) Inventors: Jon Fagerness, Blaine, MN (US); William L. Bunnelle, Ham Lake, MN (US); Sebastijan Bach, Charlotte, NC (US)

(21) Appl. No.: 18/807,206

(22) Filed: Aug. 16, 2024

Related U.S. Application Data
(60) Provisional application No. 63/533,527, filed on Aug. 18, 2023.

(51) Int. Cl. C09J 123/02; C09J 153/00

(52) U.S. Cl. CPC C09J 123/02; C09J 153/00

(57) ABSTRACT

The present disclosure provides hot-melt adhesive compositions comprising a non-virgin polymeric material and methods of preparing such hot-melt adhesive compositions.

### CROSS-REFERENCE TO RELATED APPLICATION

This application claims the benefit of U.S. Provisional Application No. 63/533,527, filed Aug. 18, 2023, the contents of which are incorporated herein by reference.

### BACKGROUND

Adhesives are widely used in various industries for bonding different materials together. Traditional adhesives often contain petroleum-based waxes and polymers, which increase environmental polymer load. Thus, there is a need for sustainable alternatives that minimize the environmental impact without compromising adhesive performance.

### SUMMARY

The present document relates to hot-melt adhesives that can be formulated with recycled, non-virgin polymeric materials. In some embodiments, the polymer includes non-virgin polypropylene, which was ignored as a suitable raw material for adhesives because it can exhibit neither beneficial adhesion properties nor favorable wetting behavior necessary to form a strong bond.

Accordingly, aspects of the present disclosure provide a hot-melt adhesive composition comprising a non-virgin polymeric material.

In some embodiments, the non-virgin polymeric material is collected from fabrics, non-woven fabrics, textiles, other fibrous materials, or a combination of any of these.

In some embodiments, the non-virgin polymeric material has a viscosity of less than about 500,000 centipoise (cps) at a temperature of 190° C. In some embodiments, the non-virgin polymeric material has a viscosity from about 100 to 10,000 cps at a temperature of 190° C. In some embodiments, the non-virgin polymeric material has a viscosity from about 500 to 5,000 cps at a temperature of 190° C. or any other ranges described herein.

In some embodiments, the hot-melt adhesive composition has a viscosity from about 5,000 to 150,000 cps at a temperature of 190° C. In some embodiments, the hot-melt adhesive composition has a viscosity from about 3,500 to 55,000 cps at a temperature of 190° C. In some embodiments, the hot-melt adhesive composition has a viscosity from about 850 to 25,000 cps at a temperature of 190° C. or any other ranges described herein.

In some embodiments, the non-virgin polymeric material comprises polypropylene.

In some embodiments, the hot-melt adhesive composition comprises at least about 1% of the non-virgin polymeric material. In some embodiments, the hot-melt adhesive composition comprises from about 3 to 10% of the non-virgin polymeric material. In some embodiments, the hot-melt adhesive composition comprises from about 5 to 25% of the non-virgin polymeric material. In some embodiments, the hot-melt adhesive composition comprises from about 10 to 60% of the non-virgin polymeric material or any other ranges described herein.

In some embodiments, the hot-melt adhesive composition described herein further comprises a polymer. In some embodiments, the polymer comprises amorphous poly alpha olefin (APAO), metallocene polyolefin, ethylene vinyl acetate (EVA), styrene-isoprene-styrene (SIS), poly(styrene-butadiene-styrene) (SBS), styrene-ethylene-butylene-styrene (SEBS), ethylene n-butyl acrylate (ENBA), polybutylene, polypropylene, polyethylene, maleic anhydride (MAH) functionalized polymer, polystyrene, styrene, polyacrylate, acrylic, a combination thereof, or a copolymer thereof.

In some embodiments, the hot-melt adhesive composition described herein further comprises a resin, an olefin, an additive, an antioxidant, a filler, a wax, or a combination thereof.

Aspects of the present disclosure provide a hot-melt adhesive composition comprising about 3 to 25 wt. % of a non-virgin polymeric material; about 0 to 50 wt. % of a resin; about 30 to 95 wt. % of an olefin; and about 0.1 to 1 wt. % of an antioxidant.

In some embodiments, the non-virgin polymeric material is collected from fabrics, non-woven fabrics, textiles, other fibrous materials, or a combination of any of these.

In some embodiments, the non-virgin polymeric material has a viscosity of less than about 500,000 cps at a temperature of 190° C. In some embodiments, the non-virgin polymeric material has a viscosity from about 100 to 10,000 cps at a temperature of 190° C. In some embodiments, the non-virgin polymeric material has a viscosity from about 500 to 5,000 cps at a temperature of 190° C. or any other ranges described herein.

In some embodiments, the hot-melt adhesive composition has a viscosity from about 850 to 150,000 cps at a temperature of 190° C. or any other ranges described herein.

In some embodiments, the non-virgin polymeric material comprises polypropylene.

Aspects of the present disclosure provide a method of preparing a hot-melt adhesive composition, the method comprising obtaining a non-virgin polymeric material having a viscosity of less than about 500,000 cps at a temperature of 190° C.; and combining the non-virgin polymeric material with a resin, an olefin, an antioxidant, a polymer, a tackifier, an additive, a filler, a wax, or a combination thereof.

In some embodiments, the non-virgin polymeric material has a viscosity from about 100 to 10,000 cps at a temperature of 190° C. In some embodiments, the non-virgin polymeric material has a viscosity from about 500 to 5,000 cps at a temperature of 190° C. or any other ranges described herein. In some embodiments, the non-virgin polymeric material comprises polypropylene.

In some embodiments, the hot-melt adhesive composition has a viscosity from about 850 to 150,000 cps at a temperature of 190° C. or any other ranges described herein. In some embodiments, the hot-melt adhesive composition comprises any one of the hot-melt adhesive compositions described herein.

Aspects of the present disclosure provide a hot-melt adhesive composition (e.g., any described herein) prepared by any method described herein.

### DETAILED DESCRIPTION

Aspects of the present disclosure provide hot-melt adhesive compositions comprising a non-virgin polymeric material. As used herein, “non-virgin polymeric material” or “repurposed polymeric material” or “recycled polymeric material,” which can be used interchangeably, refers to a polymeric material that was previously used (e.g., used for consumer or industrial purposes) and then recovered for further use.

Hot-melt adhesive compositions described herein can offer several advantages compared to traditional adhesives including, but not limited to, one or more of the following:
(i) Improved environmental sustainability resulting, at least in part, from hot-melt adhesive compositions described herein that comprise non-virgin polymeric materials, as compared to traditional adhesives that comprise virgin, petroleum-based polymers or to traditional compositions that involve solvents that emit volatile organic compounds (VOCs). Thus, the hot-melt adhesive compositions described herein provide an environmentally friendly alternative to traditional adhesives or traditional compositions of adhesives. Environmental sustainability can be determined in any useful manner, such as by reduction in carbon foot print or by increased valuation of a waste stream including such polymeric materials. By repurposing polymeric materials, the hot-melt adhesive compositions herein can reduce waste and/or lower the carbon footprint, aligning with the principles of a circular economy.
(ii) Increased productivity and efficiency in applications (e.g., woodworking applications, gasketing applications, non-woven material bonding, packaging applications, and the like) resulting, at least in part, from accelerated curing times of hot-melt adhesive compositions described herein, as compared to traditional adhesives.
(iii) Increased sealing performance resulting, at least in part, from hot-melt adhesive compositions described herein that create a more robust seal in the presence of temperature fluctuations or high levels of vibration and/or pressure, as compared to traditional adhesives. The hot-melt adhesive compositions described herein can be designed to withstand a wide range of operating conditions, including exposure to harsh chemicals, oils, fuels, and environmental elements.

The hot-melt adhesive compositions described herein can be used in any application known in the art or described herein. In some embodiments, the hot-melt adhesive compositions can be used in woodworking applications, gasketing applications, bonding of non-woven materials, and packaging applications.

Other features and advantages will be apparent from the following detailed description, and from the claims.

### Hot-Melt Adhesive Compositions

The present disclosure provides hot-melt adhesive compositions comprising a non-virgin polymeric material described herein.

The hot-melt adhesive compositions described herein can have any viscosity suitable for use of the hot-melt adhesive compositions in applications including those described herein such as woodworking applications, gasketing applications, bonding applications (e.g., non-woven to non-woven bonding, foam bonding, and the like), assembly applications (e.g., mattress assembly, pocket spring assembly, and the like), and packaging applications. See Examples below.

In some embodiments, the hot-melt adhesive composition has a viscosity less than about 500,000 cps at a temperature of about 190° C., e.g., less than 450,000 cps, less than 400,000 cps, less than 350,000 cps, less than 300,000 cps, less than 250,000 cps, less than 200,000 cps, less than 150,000 cps, less than 100,000 cps, less than 75,000 cps, less than 50,000 cps, less than 45,000 cps, less than 40,000 cps, less than 35,000 cps, less than 30,000 cps, less than 25,000 cps, less than 20,000 cps, less than 15,000 cps, less than 10,000 cps, or less than 5,000 cps at a temperature of 190° C., as well as other viscosities described herein (e.g., for a non-virgin polymeric material).

In some embodiments, the hot-melt adhesive composition has a viscosity from about 850 to 150,000 cps at a temperature of about 190° C., e.g., from 1,000 to 150,000 cps, 2,000 to 150,000 cps, 5,000 to 150,000 cps, 7,000 to 150,000 cps, 10,000 to 150,000 cps, 20,000 to 150,000 cps, 25,000 to 150,000 cps, 50,000 to 150,000 cps, 75,000 to 150,000 cps, 100,000 to 150,000 cps, 125,000 to 150,000 cps, 950 to 150,000 cps, 950 to 125,000 cps, 950 to 100,000 cps, 950 to 75,000 cps, 950 to 50,000 cps, 950 to 25,000 cps, 950 to 10,000 cps, 950 to 5,000 cps, 1,500 to 150,000 cps, 1,500 to 125,000 cps, 1,500 to 100,000 cps, 1,500 to 75,000 cps, 1,500 to 50,000 cps, 1,500 to 25,000 cps, 1,500 to 10,000 cps, 1,500 to 5,000 cps, 3,000 to 150,000 cps, 3,000 to 125,000 cps, 3,000 to 100,000 cps, 3,000 to 75,000 cps, 3,000 to 50,000 cps, 3,000 to 25,000 cps, 3,000 to 10,000 cps, 3,000 to 5,000 cps, 5,000 to 125,000 cps, 5,000 to 100,000 cps, 5,000 to 75,000 cps, 5,000 to 50,000 cps, 5,000 to 25,000 cps, or 5,000 to 10,000 cps at a temperature of 190° C., as well as other viscosities described herein (e.g., for a non-virgin polymeric material).

In some embodiments, the hot-melt adhesive composition has a viscosity from about 5,000 to 150,000 cps at a temperature of about 190° C., e.g., from 10,000 to 150,000 cps, 25,000 to 150,000 cps, 50,000 to 150,000 cps, 75,000 to 150,000 cps, 100,000 to 150,000 cps, 125,000 to 150,000 cps, 10,000 to 125,000 cps, 10,000 to 100,000 cps, 10,000 to 75,000 cps, 10,000 to 50,000 cps, 10,000 to 45,000 cps, 10,000 to 40,000 cps, 10,000 to 35,000 cps, 10,000 to 30,000 cps, 10,000 to 25,000 cps, 10,000 to 20,000 cps, 5,000 to 125,000 cps, 5,000 to 100,000 cps, 5,000 to 75,000 cps, 5,000 to 50,000 cps, 5,000 to 45,000 cps, 5,000 to 40,000 cps, 5,000 to 35,000 cps, 5,000 to 30,000 cps, 5,000 to 25,000 cps, 5,000 to 20,000 cps, or 5,000 to 10,000 cps at a temperature of 190° C., as well as other viscosities described herein (e.g., for a non-virgin polymeric material).

In some embodiments, the hot-melt adhesive composition has a viscosity from about 3,500 to 55,000 cps at a temperature of about 190° C., e.g., 4,500 to 55,000 cps, 5,500 to 55,000 cps, 6,500 to 55,000 cps, 7,500 to 55,000 cps, 8,500 to 55,000 cps, 9,500 to 55,000 cps, 10,500 to 55,000 cps, 11,500 to 55,000 cps, 12,500 to 55,000 cps, 13,500 to 55,000 cps, 14,500 to 55,000 cps, 15,500 to 55,000 cps, 18,500 to 55,000 cps, 20,500 to 55,000 cps, 25,500 to 55,000 cps, 30,500 to 55,000 cps, 35,500 to 55,000 cps, 40,500 to 55,000 cps, 45,500 to 55,000 cps, 50,500 to 55,000 cps, 3,500 to 10,000 cps, 4,500 to 10,000 cps, 5,500 to 10,000 cps, 6,500 to 10,000 cps, 7,500 to 10,000 cps, 8,500 to 10,000 cps, 9,500 to 10,000 cps, 3,500 to 50,000 cps, 3,500 to 45,000 cps, 3,500 to 40,000 cps, 3,500 to 35,000 cps, 3,500 to 30,000 cps, 3,500 to 25,000 cps, 3,500 to 20,000 cps, 3,500 to 15,000 cps, 3,500 to 10,000 cps, 3,500 to 9,000 cps, 3,500 to 8,000 cps, 3,500 to 7,000 cps, 3,500 to 6,000 cps, 3,500 to 5,000 cps, or 3,500 to 4,000 cps at a temperature of 190° C., as well as other viscosities described herein (e.g., for a non-virgin polymeric material).

In some embodiments, the hot-melt adhesive composition has a viscosity from about 850 to 25,000 cps at a temperature of about 190° C., e.g., from 1,000 to 25,000 cps, 5,000 to 25,000 cps, 10,000 to 25,000 cps, 15,000 to 25,000 cps, 20,000 to 25,000 cps, 850 to 20,000 cps, 850 to 15,000 cps, 850 to 10,000 cps, 850 to 5,000 cps, 850 to 2,500 cps, or 850 to 1,000 cps at a temperature of 190° C., as well as other viscosities described herein (e.g., for a non-virgin polymeric material).

Various amounts of non-virgin polymeric material can be included in the hot-melt adhesive compositions described herein. In some embodiments, the hot-melt adhesive composition comprises at least about 1% of the non-virgin polymeric material, e.g., at least 2%, at least 3%, at least 4%, at least 5%, at least 6%, at least 7%, at least 8%, at least 9%, at least 10%, at least 15%, at least 20%, at least 25%, at least 30%, at least 35%, at least 40%, at least 45%, at least 50%, or more of a non-virgin polymeric material.

In some embodiments, the hot-melt adhesive composition comprises from about 3 to 10% of the non-virgin polymeric material, e.g., from 4 to 10%, 5 to 10%, 6 to 10%, 7 to 10%, 8 to 10%, 9 to 10%, 3 to 9%, 3 to 8%, 3 to 7%, 3 to 6%, 3 to 5%, or 3 to 4% of a non-virgin polymeric material.

In some embodiments, the hot-melt adhesive composition comprises from about 5 to 25% of the non-virgin polymeric material, e.g., from 10 to 25%, 15 to 25%, 20 to 25%, 5 to 20%, 5 to 15%, or 5 to 10% of a non-virgin polymeric material.

In some embodiments, the hot-melt adhesive composition comprises from about 10 to 60% of the non-virgin polymeric material, e.g., from 15 to 60%, 20 to 60%, 25 to 60%, 30 to 60%, 35 to 60%, 40 to 60%, 45 to 60%, 50 to 60%, 55 to 60%, 10% to 45%, 15 to 45%, 20 to 45%, 25 to 45%, 30 to 45%, 35 to 45%, 40 to 45%, 10 to 40%, 10 to 35%, 10 to 30%, 10 to 25%, 10 to 20%, or 10 to 15% of a non-virgin polymeric material.

In some embodiments, the hot-melt adhesive composition has a softening point of less than about 160° C., 159° C., 158° C., 157° C., 156° C., 155° C., 154° C., 153° C., 152° C., 151° C., or 150° C. In some embodiments, the hot-melt adhesive composition has a softening point of greater than about 75° C., 80° C., 85° C., 90° C., 95° C., 100° C., or more. In some embodiments, the hot-melt adhesive composition has a softening point from about 40° C. to 160° C., e.g., from 50° C. to 160° C., 60° C. to 160° C., 70° C. to 160° C., 80° C. to 160° C., 40° C. to 155° C., 40° C. to 150° C., 40° C. to 145° C., 40° C. to 140° C., 40° C. to 135° C., or 40° C. to 130° C.

In some embodiments, the hot-melt adhesive composition exhibits good adhesion at low and high temperatures, strong bonding for various substrates (e.g., a SAFT with 500 g of Kraft Paper having a pass temperature greater than about 40° C. or a pass temperature from about 50 to 140° C.; a PAFT with 100 g of Kraft Paper having a pass temperature greater than about 35° C. or a pass temperature from about 40 to 60° C.; a SAFT with 500 g of 45 gsm (grams per square metre) for a non-woven having a pass temperature greater than about 40° C. or a pass temperature from about 40 to 80° C.; and/or a PAFT with 100 g of 45 gsm for a non-woven having a pass temperature greater than about 40° C. or a pass temperature from about 40 to 60° C.), thermal stability, a fast set time, a long open time (e.g., an open time greater than about 60 seconds (sec), 120 sec, 180 sec, or 600 sec; or from about 60 to 1,200 sec), a high softening point (e.g., greater than about 75° C., 80° C., 85° C., 90° C., 95° C., 100° C., or more; or from about 70 to 165° C.), a high viscosity (e.g., greater than about 1,000 cps at about 350° F.; or from about 1,000 to 30,000 cps at about 350° F.), robust hardness (e.g., a Shore A hardness from about 70 to 90), penetration resistance (e.g., a needle penetration from about 20 to 90), and/or a maximum amount of repurposed waste material.

In some embodiments, the hot-melt composition exhibits an open time of greater than about five seconds and 100% fiber tear at room temperature using carton as a substrate.

In some embodiments, the hot-melt composition exhibits a heat shear failure temperature of greater than about 55° C. (e.g., greater than 60° C., 65° C., 70° C., 75° C., 80° C., 85° C., 90° C., 95° C., or 100° C.) using a 100 g or a 500 g weight bonding non-woven to non-woven and increasing the temperature by 5° C. over a period of about 15 minutes, such as in accordance with ASTM test method D4498.

In some embodiments, the hot-melt composition exhibits a removable character and contains but not limited to more than about 10 wt. % of a tackifier. In some embodiments, the hot-melt composition provides a pressure-sensitive adhesive.

In some embodiments, the hot-melt adhesive composition (or the non-virgin polymeric material) exhibits one or more characteristics indicative of heat history or melt history. Without wishing to be limited by mechanism or theory, polymers are typically processed in the presence of heat, such as by melting, extruding, thermoforming, annealing, and the like. Exposure to heat can result in certain optical, chemical, physical, structural, or other measurable changes to the polymer, in which such changes can be used to characterize the extent of heat history for the polymer. In some embodiments, a non-virgin polymeric material may exhibit one or more characteristics indicative of heat history that are distinguishable from that of a virgin polymeric material. Such characteristics may arise from the polymer itself (e.g., changes in crystallization structure), from additives employed with the polymer (e.g., degradation of additives), and/or from interactions between the polymer and one or more additives. Non-limiting examples of such characteristics include gloss, haze, color, melt tension, density, tear strength, ultimate tensile strength, tensile yield strength, tensile elongation at yield, tensile break strength, tensile elongation at break, tensile modulus of elasticity, secant modulus of elasticity dart strength, impact resistance, or a combination of any of these, as well as changes in any of these as compared between the non-virgin and virgin forms of the polymeric material. Such characteristics may be determined for a composition including the polymeric material (e.g., a hot-melt adhesive composition) or the polymeric material (e.g., a non-virgin polymeric material or a virgin polymeric material).

The compositions herein can facilitate economical or strategic use of a waste stream. In some embodiments, a waste stream can be employed to form a non-virgin polymeric material, and a composition including the non-virgin polymeric material can be provided back to a producer that contributes to that waste stream.

### Non-Virgin Polymeric Material

Non-virgin polymeric material for use in hot-melt adhesive compositions described herein can be collected from any source suitable for recovering polymeric material. Non-limiting examples of sources of non-virgin polymeric material include fabrics, non-woven fabrics, textiles, other fibrous materials, or a combination of any these.

Non-virgin polymeric material for use in hot-melt adhesive compositions described herein can be recovered from post-consumer waste streams, post-industrial waste streams, post-commercial waste streams, or a combination thereof. In some embodiments, non-virgin polymeric material is recovered from mattresses, drinking bottles, bottle caps, containers, packaging, or a combination thereof.

Non-virgin polymeric material can have any viscosity suitable for use of the non-virgin polymeric material in hot-melt adhesive compositions described herein. In some embodiments, the non-virgin polymeric material has a viscosity of less than 500,000 cps at a temperature of 190° C., e.g., less than 250,000 cps, less than 100,000 cps, less than 50,000 cps, less than 10,000 cps, or less than 5,000 cps at a temperature of 190° C., as well as other viscosities described herein (e.g., for a composition).

In some embodiments, the non-virgin polymeric material has a viscosity from about 100 to 500,000 cps at a temperature of about 190° C., e.g., from 100 to 400,000 cps, 100 to 300,000 cps, 100 to 200,000 cps, 100 to 100,000 cps, 100 to 50,000 cps, 100 to 10,000 cps, 100 to 5,000 cps, 100 to 4,000 cps, 100 to 3,000 cps, 100 to 2,000 cps, 100 to 1,000 cps, 300 to 500,000 cps, 300 to 400,000 cps, 300 to 300,000 cps, 300 to 200,000 cps, 300 to 100,000 cps, 300 to 50,000 cps, 300 to 10,000 cps, 300 to 5,000 cps, 300 to 4,000 cps, 300 to 3,000 cps, 300 to 2,000 cps, 300 to 1,000 cps, 500 to 500,000 cps, 500 to 400,000 cps, 500 to 300,000 cps, 500 to 200,000 cps, 500 to 100,000 cps, 500 to 50,000 cps, 500 to 10,000 cps, 500 to 5,000 cps, 500 to 4,000 cps, 500 to 3,000 cps, 500 to 2,000 cps, 500 to 1,000 cps, 1,000 to 500,000 cps, 1,000 to 400,000 cps, 1,000 to 300,000 cps, 1,000 to 200,000 cps, 1,000 to 100,000 cps, 1,000 to 50,000 cps, 1,000 to 10,000 cps, 1,000 to 5,000 cps, 1,000 to 4,000 cps, 1,000 to 3,000 cps, 1,000 to 2,000 cps, 3,000 to 500,000 cps, 3,000 to 400,000 cps, 3,000 to 300,000 cps, 3,000 to 200,000 cps, 3,000 to 100,000 cps, 3,000 to 50,000 cps, 3,000 to 10,000 cps, 3,000 to 5,000 cps, 3,000 to 4,000 cps, 5,000 to 500,000 cps, 5,000 to 400,000 cps, 5,000 to 300,000 cps, 5,000 to 200,000 cps, 5,000 to 100,000 cps, 5,000 to 50,000 cps, 5,000 to 10,000 cps, 7,000 to 500,000 cps, 7,000 to 400,000 cps, 7,000 to 300,000 cps, 7,000 to 200,000 cps, 7,000 to 100,000 cps, 7,000 to 50,000 cps, 7,000 to 10,000 cps, 10,000 to 500,000 cps, 10,000 to 400,000 cps, 10,000 to 300,000 cps, 10,000 to 200,000 cps, 10,000 to 100,000 cps, 10,000 to 50,000 cps, 30,000 to 500,000 cps, 30,000 to 400,000 cps, 30,000 to 300,000 cps, 30,000 to 200,000 cps, 30,000 to 100,000 cps, 30,000 to 50,000 cps, 50,000 to 500,000 cps, 50,000 to 400,000 cps, 50,000 to 300,000 cps, 50,000 to 200,000 cps, 50,000 to 100,000 cps, 70,000 to 500,000 cps, 70,000 to 400,000 cps, 70,000 to 300,000 cps, 70,000 to 200,000 cps, 70,000 to 100,000 cps, 100,000 to 500,000 cps, 100,000 to 400,000 cps, 100,000 to 300,000 cps, or 100,000 to 200,000 cps at a temperature of 190° C., as well as other viscosities described herein (e.g., for a composition).

In some embodiments, the non-virgin polymeric material has a viscosity from 100 to 10,000 cps at a temperature of 190° C., e.g., from 500 to 10,000 cps, 1,000 to 10,000 cps, 2,500 to 10,000 cps, 5,000 to 10,000 cps, 7,500 to 10,000 cps, 100 to 7,500 cps, 100 to 5,000 cps, 100 to 2,500 cps, 100 to 1,000 cps, or 100 to 500 cps at a temperature of 190° C., as well as other viscosities described herein (e.g., for a composition).

In some embodiments, the non-virgin polymeric material has a viscosity from 500 to 5,000 cps at a temperature of 190° C., e.g., from 1,000 to 5,000 cps, 2,000 to 5,000 cps, 3,000 to 5,000 cps, 4,000 to 5,000 cps, 500 to 4,000 cps, 500 to 3,000 cps, 500 to 2,000 cps, or 500 to 1,000 cps at a temperature of 190° C., as well as other viscosities described herein (e.g., for a composition).

Any non-virgin polymeric material can be included in the hot-melt adhesive compositions described herein. Non-limiting examples of non-virgin polymeric materials include polypropylene (PP), polyethylene (PE), high-density polyethylene (HDPE), polystyrene (PS), acrylonitrile butadiene styrene (ABS), polyamide (PA), polycarbonate (PC), polyester, or a combination thereof. In some embodiments, the non-virgin polymeric material includes homopolymers, copolymers, or mixtures thereof. In some embodiments, the non-virgin polymeric material comprises uni-modal or multi-modal molecular weight distributions.

In some embodiments, the non-virgin polymeric material comprises recycled PP (rePP). In some embodiments, the polypropylene includes homopolymers, copolymers (e.g., a copolymer including propylene and an alpha olefin, such as any alpha olefin monomer described herein, including a C₂₋₁₆ alpha olefin monomer), and mixtures of different propylene polymers. Non-limiting examples of polypropylene copolymers include propylene-ethylene, propylene-butene, propylene-hexene, propylene-octene, and combinations thereof. In some embodiments, the polypropylene copolymer includes from about 50 to 99 wt. % of a propylene monomer and about 1 to 50 wt. % of an alpha olefin monomer. The polypropylene can be unmodified or modified (e.g., hydrogenated, styrenated, esterified, grafted (e.g., with a reactive monomer, such as maleic anhydride), and the like).

The polypropylene may contain blocks of isotactic polypropylene and blocks of atactic polypropylene, which can influence their properties and performance. In some embodiments, these polymer compositions exhibit a broad range of characteristics that make them suitable for various applications, offering versatility, improved mechanical properties, and/or tailored functionality.

The non-virgin polymeric material can be in any form suitable for use in the hot-melt adhesive compositions described herein. In some embodiments, the non-virgin polymeric material comprises a shredded material, a granulated material, or a combination thereof, as well as treated forms of any of these. Any of these forms can include free flowing forms, such as those provided as granules, pellets, and the like.

The non-virgin polymeric material can have a low molecular weight. In some embodiments, the non-virgin polymeric material can be treated to lower the molecular weight. In such instances, the non-virgin polymeric material can be treated with an oxidizing agent (e.g., peroxide), water, acid (e.g., a Bronsted acid), a catalyst (e.g., a metal catalyst), or a combination thereof. Without wishing to be bound by theory, the presence of low molecular weight non-virgin polymeric material can improve the wetting behavior of the hot-melt adhesive composition.

Various amounts of non-virgin polymeric material can be included in the hot-melt adhesive compositions described herein. In some embodiments, the hot-melt adhesive composition comprises from about 3 to 60 wt. % of a non-virgin polymeric material (e.g., one or more non-virgin polymeric materials), e.g., from 3 to 55 wt. %, 3 to 50 wt. %, 3 to 45 wt. %, 3 to 40 wt. %, 3 to 35 wt. %, 3 to 30 wt. %, 3 to 25 wt. %, 3 to 20 wt. %, 3 to 15 wt. %, 3 to 10 wt. %, 3 to 5 wt. %, 5 to 60 wt. %, 5 to 55 wt. %, 5 to 50 wt. %, 5 to 45 wt. %, 5 to 40 wt. %, 5 to 35 wt. %, 5 to 30 wt. %, 5 to 25 wt. %, 5 to 20 wt. %, 10 to 60 wt. %, 10 to 55 wt. %, 10 to 50 wt. %, 10 to 45 wt. %, 10 to 40 wt. %, 10 to 35 wt. %, 10 to 30 wt. %, 10 to 25 wt. %, 10 to 20 wt. %, 15 to 60 wt. %, 15 to 55 wt. %, 15 to 50 wt. %, 15 to 45 wt. %, 15 to 40 wt. %, 15 to 35 wt. %, 15 to 30 wt. %, 15 to 25 wt. %, 15 to 20 wt. %, 20 to 60 wt. %, 20 to 55 wt. %, 20 to 50 wt. %, 20 to 45 wt. %, 20 to 40 wt. %, 20 to 35 wt. %, 20 to 30 wt. %, 20 to 25 wt. %, 25 to 60 wt. %, 25 to 55 wt. %, 25 to 50 wt. %, 25 to 45 wt. %, 25 to 40 wt. %, 25 to 35 wt. %, 25 to 30 wt. %, 30 to 60 wt. %, 30 to 55 wt. %, 30 to 50 wt. %, 30 to 45 wt. %, 30 to 40 wt. %, 30 to 35 wt. %, 35 to 60 wt. %, 35 to 55 wt. %, 35 to 50 wt. %, 35 to 45 wt. %, or 35 to 40 wt. % of a non-virgin polymeric material in the composition. By “weight percent” or “wt. %” means a percentage based on the ratio of a weight of a first component (e.g., a non-virgin polymeric material) to a weight of a second component (e.g., a composition, such as a hot-melt adhesive composition).

### Additional Components

The hot-melt adhesive compositions described herein can comprise a non-virgin polymeric material and one or more additional components such as a resin (e.g., Eastotac™ H-130W, a hydrogenated aliphatic resin from Synthomer, London, UK), an olefin (e.g., Vestoplast® 828, amorphous poly-alpha-olefins, produced with three monomers including ethylene, propylene and butene-1 from Evonik Industries, Essen, Germany), an antioxidant (e.g., Irganox® 1010, a primary phenolic antioxidant stabilizer from BASF, Ludwigshafen, Germany), a polymer (e.g., Engage™ EG8200, a polyolefin elastomer from DOW, Midland, MI), an additive (e.g., Drakeol 35, mineral oil from Penreco, Karns City, PA), a filler (e.g., Omyacarb® 15, calcium carbonate from Omya, Oftringen, Switzerland), or a wax (e.g., Sasol H1, a Fischer-Tropsch high melting point wax from Sasol Chemicals, Sasol, South Africa). One or more of each type of component may be present.

Any of the hot-melt adhesive compositions described herein can comprise a resin. Non-limiting examples of a resin include a hydrocarbon resin, a rosin resin, an aliphatic resin, an aromatic resin, a mixed aromatic-aliphatic resin, a terpene resin, a phenolic resin, styrenic resins, derivatives thereof (e.g., hydrogenated, styrenated, or esterified forms thereof), and combinations thereof.

Various amounts of a resin can be included in the hot-melt adhesive compositions described herein. In some embodiments, the hot-melt adhesive composition comprises from about 0 to 50 wt. % of a resin (e.g., one or more resins), e.g., from 1 to 50 wt. %, 2 to 50 wt. %, 3 to 50 wt. %, 4 to 50 wt. %, 5 to 50 wt. %, 10 to 50 wt. %, 15 to 50 wt. %, 20 to 50 wt. %, 25 to 50 wt. %, 30 to 50 wt. %, 35 to 50 wt. %, 40 to 50 wt. %, 45 to 50 wt. %, 1 to 40 wt. %, 2 to 40 wt. %, 3 to 40 wt. %, 4 to 40 wt. %, 5 to 40 wt. %, 10 to 40 wt. %, 15 to 40 wt. %, 20 to 40 wt. %, 25 to 40 wt. %, 30 to 40 wt. %, 35 to 40 wt. %, 0 to 45 wt. %, 0 to 40 wt. %, 0 to 35 wt. %, 0 to 30 wt. %, 0 to 25 wt. %, 0 to 20 wt. %, 0 to 15 wt. %, 0 to 10 wt. %, or 0 to 5 wt. % of a resin in the composition.

Any of the hot-melt adhesive compositions described herein can comprise an olefin. Non-limiting examples of an olefin include a poly alpha olefin, such as, e.g., amorphous poly alpha olefin (APAO); a polyolefin, such as, e.g., amorphous polyolefin (APO); or a combination thereof.

Various amounts of an olefin can be included in the hot-melt adhesive compositions described herein. In some embodiments, the hot-melt adhesive composition comprises from about 30 to 95 wt. % of an olefin (e.g., one or more olefins), e.g., from 35 to 95 wt. %, 40 to 95 wt. %, 45 to 95 wt. %, 50 to 95 wt. %, 55 to 95 wt. %, 60 to 95 wt. %, 65 to 95 wt. %, 70 to 95 wt. %, 75 to 95 wt. %, 80 to 95 wt. %, 85 to 95 wt. %, 90 to 95 wt. %, 30 to 90 wt. %, 30 to 85 wt. %, 30 to 80 wt. %, 30 to 75 wt. %, 30 to 70 wt. %, 30 to 65 wt. %, 30 to 60 wt. %, 30 to 55 wt. %, 30 to 50 wt. %, 30 to 45 wt. %, 30 to 40 wt. %, 30 to 35 wt. %, 50 to 90 wt. %, 50 to 85 wt. %, 50 to 80 wt. %, 50 to 75 wt. %, 50 to 70 wt. %, 50 to 65 wt. %, 50 to 60 wt. %, or 50 to 55 wt. % of an olefin in the composition.

Any of the hot-melt adhesive compositions described herein can comprise an antioxidant. Non-limiting examples of an antioxidant include aromatic amines, butylated hydroxyanisole (BHA), butylated hydroxytoluene (BHT), phenol (e.g., hindered phenols), phosphites, phosphates, or a combination thereof.

Various amounts of an antioxidant can be included in the hot-melt adhesive compositions described herein. In some embodiments, the hot-melt adhesive composition comprises from about 0.01 to 3 wt. % of an antioxidant (e.g., one or more antioxidants), e.g., from 0.05 to 3 wt. %, 0.1 to 3 wt. %, 0.2 to 3 wt. %, 0.3 to 3 wt. %, 0.4 to 3 wt. %, 0.5 to 3 wt. %, 0.6 to 3 wt. %, 0.7 to 3 wt. %, 0.8 to 3 wt. %, 0.9 to 3 wt. %, 0.01 to 2 wt. %, 0.05 to 2 wt. %, 0.1 to 2 wt. %, 0.2 to 2 wt. %, 0.3 to 2 wt. %, 0.4 to 2 wt. %, 0.5 to 2 wt. %, 0.6 to 2 wt. %, 0.7 to 2 wt. %, 0.8 to 2 wt. %, 0.9 to 2 wt. %, 0.01 to 1 wt. %, 0.05 to 1 wt. %, 0.1 to 1 wt. %, 0.2 to 1 wt. %, 0.3 to 1 wt. %, 0.4 to 1 wt. %, 0.5 to 1 wt. %, 0.6 to 1 wt. %, 0.7 to 1 wt. %, 0.8 to 1 wt. %, 0.9 to 1 wt. %, 0.01 to 0.9 wt. %, 0.01 to 0.8 wt. %, 0.01 to 0.7 wt. %, 0.01 to 0.6 wt. %, 0.01 to 0.5 wt. %, 0.01 to 0.4 wt. %, 0.01 to 0.3 wt. %, 0.01 to 0.2 wt. %, 0.1 to 0.9 wt. %, 0.1 to 0.8 wt. %, 0.1 to 0.7 wt. %, 0.1 to 0.6 wt. %, 0.1 to 0.5 wt. %, 0.1 to 0.4 wt. %, 0.1 to 0.3 wt. %, or 0.1 to 0.2 wt. % of an antioxidant in the composition.

Any of the hot-melt adhesive compositions described herein can comprise a polymer. In some embodiments, the polymer can include a component that is compatible with a non-virgin polymeric material. Compatibility can be assessed by visual observation of the molten composition. In some embodiments, a compatible mixture can appear transparent and/or homogeneous without appearing milky/hazy or grainy. Non-limiting examples of a polymer include a poly alpha olefin (PAO), including amorphous poly alpha olefin (APAO), a polyolefin, including amorphous polyolefin (APO) or metallocene polyolefin (mPO), ethylene vinyl acetate (EVA), styrene-isoprene-styrene (SIS), styrene-butadiene (SB), styrene-butadiene-styrene (SBS), styrene-ethylene-butylene-styrene (SEBS), styrene-ethylene-propylene-styrene (SEPS), styrene-isoprene-propylene-styrene (SIPS), styrene-ethylene-ethylene, propylene-styrene (SEEPS), ethylene methacrylate, ethylene n-butyl acrylate (ENBA), polybutylene, polypropylene, polyethylene, maleic anhydride (MAH) functionalized polymer, polystyrene, styrene, polyacrylate, acrylic, polyamide, rubber-based polymer, a combination thereof, or a copolymer thereof (e.g., including block copolymers thereof). The polymer can include virgin or non-virgin forms, as well as combinations thereof.

In some embodiments, a metallocene polyolefin includes a metallocene-catalyzed polyolefin based on propylene, ethylene, and/or C₄ or higher monomers or co-monomers. In some embodiments, a metallocene polyolefin includes a metallocene-catalyzed polyolefin based on C₂₋₁₆ monomers (e.g., C₂₋₁₄, C₂₋₁₂, C₂₋₁₀, C₂₋₈, C₃₋₁₆, C₃₋₁₄, C₃₋₁₂, C₃₋₁₀, C₃₋₈, C₄₋₁₆, C₄₋₁₄, C₄₋₁₂, C₄₋₁₀, or C₄₋₈ monomers). In some embodiments, the C₂₋₁₆ monomer is a C₂₋₁₆ alpha olefin monomer. Non-limiting examples of monomers include ethylene (C₂), propylene (C₃), 1-butene (C₄), isobutene (C₄), 1-pentene (C₅), cis-2-pentene (C₅), trans-2-pentene (C₅), 2-methyl-1-butene (C₅), 3-methyl-1-butene (C₅), 1-hexene (C₆), 2-methyl-1-pentene (C₆), 3-methyl-1-pentene (C₆), 4-methyl-1-pentene (C₆), 2,3-dimethyl-1-butene (C₆), 3,3-dimethyl-1-butene (C₆), 2-ethyl-1-butene (C₆), 1-heptene (C₇), 3-methyl-1-hexene (C₇), 1-octene (C₈), 1-nonene (C₉), 1-decene (C₁₀), 1-dodecene (C₁₂), and combinations of any of these. Such monomers can be used to provide homopolymers or copolymers.

Various amounts of a polymer can be included in the hot-melt adhesive compositions described herein. In some embodiments, the hot-melt adhesive composition comprises from about 0 to 97 wt. % of a polymer (e.g., one or more polymers), e.g., from 1 to 97 wt. %, 5 to 97 wt. %, 10 to 97 wt. %, 15 to 97 wt. %, 20 to 97 wt. %, 25 to 97 wt. %, 30 to 97 wt. %, 35 to 97 wt. %, 40 to 97 wt. %, 45 to 97 wt. %, 50 to 97 wt. %, 55 to 97 wt. %, 60 to 97 wt. %, 65 to 97 wt. %, 70 to 97 wt. %, 75 to 97 wt. %, 80 to 97 wt. %, 85 to 97 wt. %, 90 to 97 wt. %, 95 to 97 wt. %, 0 to 95 wt. %, 0 to 90 wt. %, 0 to 85 wt. %, 0 to 80 wt. %, 0 to 75 wt. %, 0 to 70 wt. %, 0 to 65 wt. %, 0 to 60 wt. %, 0 to 55 wt. %, 0 to 50 wt. %, 0 to 45 wt. %, 0 to 40 wt. %, 0 to 35 wt. %, 0 to 30 wt. %, 0 to 25 wt. %, 0 to 20 wt. %, 0 to 15 wt. %, 0 to 10 wt. %, or 0 to 5 wt. % of a polymer in the composition.

Any of the hot-melt adhesive compositions described herein can comprise a tackifier. Non-limiting examples of a tackifier include a resin (e.g., any described herein), a rosin derivative, a hydrogenated resin, a hydrocarbon polymer, a hydrocarbon oligomer, an aromatic monomer (e.g., a styrenic monomer or an indene monomer), an aliphatic monomer (e.g., a C₁₋₆ linear, branched, or cyclic aliphatic monomer), a mixed aromatic-aliphatic monomer, or a combination thereof. Yet other non-limiting examples of tackifiers include gum rosin, tall oil rosin, wood rosin, derivatives thereof (e.g., hydrogenated, styrenated, or esterified forms thereof), and combinations thereof.

Various amounts of a tackifier can be included in the hot-melt adhesive compositions described herein. In some embodiments, the hot-melt adhesive composition comprises from about 0 to 50 wt. % of a tackifier (e.g., one or more tackifiers), e.g., from 1 to 50 wt. %, 5 to 50 wt. %, 10 to 50 wt. %, 15 to 50 wt. %, 20 to 50 wt. %, 25 to 50 wt. %, 30 to 50 wt. %, 35 to 50 wt. %, 40 to 50 wt. %, 45 to 50 wt. %, 0 to 45 wt. %, 0 to 40 wt. %, 0 to 35 wt. %, 0 to 30 wt. %, 0 to 25 wt. %, 0 to 20 wt. %, 0 to 15 wt. %, 0 to 10 wt. %, 0 to 5 wt. %, or 0 to 1 wt. % of a tackifier in the composition.

Any of the hot-melt adhesive compositions described herein can comprise an additive. Non-limiting examples of an additive include a dye, a pigment, a surfactant, a plasticizer, an adhesion promoter, a thickener, a filler, a wax, or other functional additives (anti-bacterial, anti-insect, and the like) or a combination thereof.

Various amounts of an additive can be included in the hot-melt adhesive compositions described herein. In some embodiments, the hot-melt adhesive composition comprises from about 0 to 70 wt. % of an additive (e.g., one or more additives), e.g., from 1 to 70 wt. %, 5 to 70 wt. %, 10 to 70 wt. %, 15 to 70 wt. %, 20 to 70 wt. %, 25 to 70 wt. %, 30 to 70 wt. %, 35 to 70 wt. %, 40 to 70 wt. %, 45 to 70 wt. %, 50 to 70 wt. %, 55 to 70 wt. %, 60 to 70 wt. %, 65 to 70 wt. %, 0 to 65 wt. %, 0 to 60 wt. %, 0 to 55 wt. %, 0 to 50 wt. %, 0 to 45 wt. %, 0 to 40 wt. %, 0 to 35 wt. %, 0 to 30 wt. %, 0 to 25 wt. %, 0 to 20 wt. %, 0 to 15 wt. %, 0 to 10 wt. %, or 0 to 5 wt. % of an additive in the composition.

Any of the hot-melt adhesive compositions described herein can comprise a filler. Non-limiting examples of a filler include an inorganic filler such as barium sulfate, calcium carbonate, clay, glass particles (e.g., fibers, powder, spheres), silica (e.g., fumed silica and/or treated silica), talc, organic powders (e.g., organic powders based on lignite, starch, and/or wood) or a combination thereof. The filler can have any useful size (e.g., a particle size, such as from 1 to 50 μm).

Various amounts of a filler can be included in the hot-melt adhesive compositions described herein. In some embodiments, the hot-melt adhesive composition comprises from about 0 to 90 wt. % of a filler (e.g., one or more fillers), e.g., from 1 to 90 wt. %, 5 to 90 wt. %, 10 to 90 wt. %, 15 to 90 wt. %, 20 to 90 wt. %, 25 to 90 wt. %, 30 to 90 wt. %, 35 to 90 wt. %, 40 to 90 wt. %, 45 to 90 wt. %, 50 to 90 wt. %, 55 to 90 wt. %, 60 to 90 wt. %, 65 to 90 wt. %, 70 to 90 wt. %, 75 to 90 wt. %, 80 to 90 wt. %, 85 to 90 wt. %, 0 to 85 wt. %, 0 to 80 wt. %, 0 to 75 wt. %, 0 to 70 wt. %, 0 to 65 wt. %, 0 to 60 wt. %, 0 to 55 wt. %, 0 to 50 wt. %, 0 to 45 wt. %, 0 to 40 wt. %, 0 to 35 wt. %, 0 to 30 wt. %, 0 to 25 wt. %, 0 to 20 wt. %, 0 to 15 wt. %, 0 to 10 wt. %, 0 to 5 wt. %, or 0 to 1 wt. % of a filler in the composition.

Any of the hot-melt adhesive compositions described herein can comprise a wax. Non-limiting examples of a wax include a petroleum wax such as a paraffin wax, a microcrystalline wax, a polyethylene wax, a polypropylene wax, a Fischer-Tropsch wax, Amid wax, Montan wax, Carnauba wax, metallocene catalyst waxes or oxidized and modified forms thereof, or a combination thereof.

Various amounts of a wax can be included in the hot-melt adhesive compositions described herein. In some embodiments, the hot-melt adhesive composition comprises from about 0 to 10 wt. % of a wax (e.g., one or more waxes), e.g., from 1 to 10 wt. %, 2 to 10 wt. %, 3 to 10 wt. %, 4 to 10 wt. %, 5 to 10 wt. %, 6 to 10 wt. %, 7 to 10 wt. %, 8 to 10 wt. %, 9 to 10 wt. %, 0 to 9 wt. %, 0 to 8 wt. %, 0 to 7 wt. %, 0 to 6 wt. %, 0 to 5 wt. %, 0 to 4 wt. %, 0 to 3 wt. %, 0 to 2 wt. %, or 0 to 1 wt. % of a wax in the composition.

A component can be present in any useful amount. In some embodiments, the hot-melt adhesive composition comprises from about 3 to 60 wt. % of a non-virgin polymeric material, about 0 to 50 wt. % of a resin, 30 to 95 wt. % of an olefin, and 0.01 to 3 wt. % of an antioxidant.

In some embodiments, the hot-melt adhesive composition comprises from about 3 to 25 wt. % of a non-virgin polymeric material, about 0 to 40 wt. % of a resin, 50 to 95 wt. % of an olefin, and 0.1 to 1 wt. % of an antioxidant.

In some embodiments, the hot-melt adhesive composition comprises from about 3 to 25 wt. % of a non-virgin polymeric material, 0 to 50 wt. % of a resin, 30 to 95 wt. % of an olefin, 0.01 to 2.0 wt. % of an antioxidant, 5 to 95 wt. % of a polymer, 0 to 60 wt. % of a tackifier, 0 to 60 wt. % of an additive, 0 to 60 wt. % of a filler, and 0 to 40 wt. % of a wax.

In some embodiments, the hot-melt adhesive composition comprises from about 3 to 25 wt. % of a non-virgin polymeric material, 0.01 to 2.0 wt. % of an antioxidant, 5 to 95 wt. % of a polymer, 0 to 60 wt. % of a tackifier, 0 to 60 wt. % of an additive, 0 to 60 wt. % of a filler, and 0 to 40 wt. % of a wax.

### Methods of Preparing Hot-Melt Adhesive Compositions

The present disclosure also provides methods of preparing any of the hot-melt adhesive compositions described herein. Such methods include obtaining a non-virgin polymeric material (e.g., any described herein) and combining the non-virgin polymeric material with a resin, a polymer, an additive, a filler, a wax, or a combination thereof.

In some embodiments, methods of preparing a hot-melt adhesive composition comprise obtaining a non-virgin polymeric material having a viscosity of less than 500,000 cps at a temperature of 190° C. and combining the non-virgin polymeric material with a resin, a polymer, an additive, a filler, a wax, or a combination thereof.

### Uses

In use, the compositions herein can be employed as an adhesive to bond different materials together. The characteristics of the composition, as well as components within the composition, can be adapted to provide desired adhesive properties for such bonding.

In some embodiments, the use includes woodworking applications (e.g., including joining of various wood components to create furniture, cabinets, and other wooden structures). In some embodiments, the hot-melt adhesive composition comprises a non-virgin polymeric material in combination with one or more polymers, waxes, additives, or other components. In some embodiments, the composition has a viscosity from about 1,000 mPa·s to 150,000 mPa·s at 180° C. or other viscosity ranges (e.g., any described herein). In some embodiments, the composition has a softening point less than about 152° C. In some embodiments, the composition provides strong adhesion between the wood surfaces, resulting in a reliable and robust bond (e.g., as determined by applying stress or loading to formed joints using a breaker bar in inch-pounds of torque). In some embodiments, the composition is characterized by a reduced curing time, as compared to a traditional adhesive. For example and without limitation, the hot-melt adhesive composition can be applied in its molten state, quickly solidifying upon cooling, thus allowing for faster assembly and production processes. This accelerated bonding time can increase efficiency and productivity in woodworking operations.

In some embodiments, the hot-melt adhesive compositions exhibit excellent compatibility with various wooden substrates, including hardwood, softwood, and composite materials. For example and without limitation, the composition can provide optimal wetting behavior, allowing for complete coverage and bonding between the wood surfaces. This compatibility can contribute to the overall performance of the composition, resulting in consistent and reliable bonding across different woodworking applications.

In some embodiments, the use includes gasketing applications (e.g., including creating a seal between two mating surfaces in various industries such as automotive, manufacturing, and construction industries). In some embodiments, the hot-melt adhesive composition comprises a non-virgin polymeric material in combination with one or more polymers, waxes, antioxidants, olefins, or other components. In some embodiments, the composition has a viscosity from about 1,000 mPa·s to 50,000 mPa·s at 180° C. or other viscosity ranges (e.g., any described herein). In some embodiments, the composition has a softening point less than about 155° C.

In some embodiments, the composition provides strong adhesion between the mating surfaces, resulting in a reliable and robust bond (e.g., as determined by applying compression stress or peel stress to the gaskets). For example and without limitation, the hot-melt adhesive composition can create and maintain a robust seal, even in a wide range of operating conditions, including exposure to harsh chemicals, oils, fuels, and environmental elements, or in applications with high levels of vibration, pressure, or temperature fluctuations. This durability ensures the integrity of the bond between mating surfaces for long-lasting performance. In some embodiments, the composition is characterized by a reduced curing time, as compared to a traditional adhesive. For example and without limitation, the hot-melt adhesive composition can be applied in its molten state, quickly solidifying upon cooling, thus allowing for efficient and productive gasketing applications. This accelerated bonding time can reduce production time and costs associated with gasketing applications.

In some embodiments, the use includes bonding applications (e.g., non-woven to non-woven bonding, foam bonding, and the like). Non-woven materials are widely used in various industries, including textile, filtration, mattress, hygiene (e.g., diapers, feminine care products, cleaning pads), medical (e.g., medical garments, disposable items), and automotive industries. In some embodiments, the hot-melt adhesive composition comprises a non-virgin polymeric material in combination with one or more resins, antioxidants, olefins, or other components. In some embodiments, the composition has a viscosity from about 1,000 mPa·s to 10,000 mPa·s at 180° C. or other viscosity ranges (e.g., any described herein). In some embodiments, the composition has a softening point less than about 152° C. In some embodiments, the composition provides excellent bonding strength between materials (e.g., non-woven materials), resulting in a reliable and robust bond (e.g., as determined by applying various stressors, including tension, compression, and/or flexing to the bond). For example and without limitation, the hot-melt adhesive composition can create and maintain a robust bond between materials that is capable of withstanding various stressors, including tension, compression, and/or flexing.

In some embodiments, the hot-melt adhesive compositions exhibits excellent flexibility and conformability, allowing for bonding materials with different textures, thicknesses, and/or densities. For example and without limitation, the hot-melt adhesive composition can penetrate the fibers of the non-woven materials, creating a strong and uniform bond throughout the entire joint. This flexibility and conformability can enable the bonding of complex-shaped, non-woven components, expanding the possibilities for product design and manufacturing. In some embodiments, the composition is characterized by a reduced curing time, as compared to a traditional adhesive. For example and without limitation, the hot-melt adhesive composition can be applied in its molten state, quickly solidifying upon cooling, thus allowing for efficient and productive bonding applications. This accelerated bonding time can reduce production time and costs associated with manufacturing operations that involve bonding applications.

In some embodiments, the use includes packaging applications (e.g., including sealing of cases, cartons, and other packaging materials). In some embodiments, the hot-melt adhesive composition comprises a non-virgin polymeric material in combination with one or more resins, olefins, antioxidants, or other components. In some embodiments, the composition has a viscosity from about 500 mPa-s to 5,000 mPa·s at 180° C. or other viscosity ranges (e.g., any described herein). In some embodiments, the composition has a softening point less than about 155° C. In some embodiments, the hot-melt adhesive compositions exhibit excellent adhesion to a wide range of substrates commonly used in packaging, including cardboard, paperboard, and plastics. For example and without limitation, the composition can exhibit high heat resistance, thus maintaining bond integrity even in challenging storage and transportation conditions.

### EXAMPLES

The examples described in this application are offered to illustrate the compositions and the methods provided herein and are not to be construed in any way as limiting their scope.

### Methods

Hot-melt adhesive compositions can be prepared by heating and mixing components. The hot-melt adhesive composition was analyzed for one or more of the following properties: Mettler softening point, Brookfield Viscosity at 350° F., shear adhesion fail temperature (SAFT), peel adhesion fail temperature (PAFT), needle penetration, open time, and hardness.

SAFT values were determined by coating a sample onto kraft paper using the test method described in ASTM method D4498.

PAFT values were determined by coating a sample onto kraft paper using the test method described in ASTM method D4498.

Needle penetration values were determined by using the test method described in ASTM method D1321-16A.

Open time was determined by using the test method described in ASTM method D4497-10.

Harness was scaled using Shore A and was determined by using the test method described in ASTM method D2240.

### Example 1: Hot-Melt Adhesive Compositions for Woodworking Applications

This Example describes hot-melt adhesive compositions for woodworking applications, which involve joining various wood components to create furniture, cabinets, and other wooden structures. Hot-melt adhesive compositions for woodworking applications are provided in Tables 1A-1B.

TABLE 1A
Hot-melt adhesive compositions for woodworking applications

| | A1 | | A2 | |
|---|---|---|---|---|
| Resin | 20-40 | wt. % | 20-40 | wt. % |
| Antioxidant | 0.25-1.0 | wt. % | 0.25-1.0 | wt. % |
| Amorphous polyolefin (APO) | 45-75 | wt. % | 45-75 | wt. % |
| Poly(methyl methacrylate) (PMMA) | 1-5 | wt. % | 1-5 | wt. % |
| Wax | 10 | wt. % | 0 | wt. % |
| Recycled polypropylene | 0 | wt. % | 10 | wt. % |

TABLE 1B
Characteristics of hot-melt adhesive compositions
for woodworking applications

| | A1 | | A2 | |
|---|---|---|---|---|
| Mettler Softening Point | 153° | C. | 155° | C. |
| Brookfield Viscosity at 350° F. | 21,130 | cps | 27,290 | cps |
| SAFT - 500 g Kraft Paper - pass temp | 125° | C. | 130° | C. |

### Example 2: Hot-Melt Adhesive Compositions for Gasketing Applications

This Example describes hot-melt adhesive compositions for gasketing applications, which involve sealing the space between two or more mating surfaces. Hot-melt adhesive compositions for gasketing applications are provided in Tables 2A-2B.

TABLE 2A
Hot-melt adhesive compositions for gasketing applications

| | B1 | | B2 | |
|---|---|---|---|---|
| Resin | 1-20 | wt. % | 1-20 | wt. % |
| Oil | 30-60 | wt. % | 30-60 | wt. % |
| Styrene-ethylene-propylene-styrene | 20-35 | wt. % | 20-25 | wt. % |
| (SEPS) | | | | |
| Antioxidant | 0.25-1.0 | wt. % | 0.25-1.0 | wt. % |
| Amorphous polyolefin (APO) | 5-20 | wt. % | 5-20 | wt. % |
| Recycled polypropylene | 0 | wt. % | 10 | wt. % |

TABLE 2B
Characteristics of hot-melt adhesive compositions
for gasketing applications

| | B1 | | B2 | |
|---|---|---|---|---|
| Mettler Softening Point | 90° | C. | 155° | C. |
| Brookfield Viscosity at 350° F. | 6,800 | cps | 22,000 | cps |
| Needle Penetration | 85 | | 40 | |
| SAFT - 500 g Kraft Paper - pass temp | 50° | C. | 125° | C. |

### Example 3: Hot-Melt Adhesive Compositions for Bonding Non-Woven Materials

This Example describes hot-melt adhesive compositions for bonding non-woven materials such as textiles, synthetic fibers, cellulose fibers, felt, or combinations thereof. Hot-melt adhesive compositions for bonding non-woven materials are provided in Tables 3A-3B.

TABLE 3A
Hot-melt adhesive compositions for bonding non-woven materials

| | C1 | | C2 | | C3 | | C4 | |
|---|---|---|---|---|---|---|---|---|
| Resin | 15-35 | wt. % | 15-35 | wt. % | 15-35 | wt. % | 15-35 | wt. % |
| Amorphous poly alpha | 60-90 | wt. % | 60-90 | wt. % | 60-90 | wt. % | 60-90 | wt. % |
| olefin (APAO) | | | | | | | | |
| Antioxidant | 0.25-1.0 | wt. % | 0.25-1.0 | wt. % | 0.25-1.0 | wt. % | 0.25-1.0 | wt. % |
| Recycled | 0 | wt. % | 5 | wt. % | 10 | wt. % | 15 | wt. % |
| polypropylene | | | | | | | | |

TABLE 3B
Characteristics of hot-melt adhesive compositions for bonding non-woven materials

| | C1 | | C2 | | C3 | | C4 | |
|---|---|---|---|---|---|---|---|---|
| Brookfield Viscosity at 350° F. | 1333 | cps | 1375 | cps | 1345 | cps | 1343 | cps |
| Open Time - Film | 600+ | sec | 600+ | sec | 180 | sec | 60 | sec |
| SAFT - 500 g 45 gsm Non-woven | 55° | C. | 60° | C. | 60° | C. | 67.5° | C. |
| PAFT - 100 g 45 gsm Non-woven | 42.5° | C. | 45° | C. | 50° | C. | 55° | C. |
| Mettler Softening Point | 81.1° | C. | 133.8° | C. | 140.8° | C. | 142.9° | C. |

| | | | | |
|---|---|---|---|---|
| Shore A | 72 | 73 | 77 | 84 |

### Example 4: Hot-Melt Adhesive Compositions for Packaging Applications

This Example describes hot-melt adhesive compositions for packaging application such as case and carton sealing applications. Hot-melt adhesive compositions for packaging applications are provided in Tables 4A-41B below.

TABLE 4A
Hot-melt adhesive compositions for packaging applications

| | D1 | | D2 | | D3 | | D4 | |
|---|---|---|---|---|---|---|---|---|
| Resin | 15-35 | wt. % | 15-35 | wt. % | 15-35 | wt. % | 15-35 | wt. % |
| Amorphous poly | 60-90 | wt. % | 60-90 | wt. % | 60-90 | wt. % | 60-90 | wt. % |
| alpha olefin (APAO) | | | | | | | | |
| Antioxidant | 0.25-1.0 | wt. % | 0.25-1.0 | wt. % | 0.25-1.0 | wt. % | 0.25-1.0 | wt. % |
| Recycled | 0 | wt. % | 5 | wt. % | 10 | wt. % | 15 | wt. % |
| polypropylene | | | | | | | | |

TABLE 4B
Characteristics of hot-melt adhesive compositions for packaging applications

| | D1 | | D2 | | D3 | | D4 | |
|---|---|---|---|---|---|---|---|---|
| Brookfield Viscosity 350° F. | 1333 | cps | 1375 | cps | 1345 | cps | 1343 | cps |
| Open Time - Film | 600+ | sec | 600+ | sec | 180 | sec | 60 | sec |
| SAFT - 500 g Kraft Paper | 57.5° | C. | 65° | C. | 77.5° | C. | 90° | C. |
| PAFT - 100 g Kraft Paper | 42.5° | C. | 45° | C. | 50° | C. | 50° | C. |
| Mettler Softening Point | 81.1° | C. | 133.8° | C. | 140.8° | C. | 142.9° | C. |

### OTHER EMBODIMENTS

It is to be understood that while the present document has been described in conjunction with the detailed description thereof, the foregoing description is intended to illustrate and not limit the scope of the present document. Other aspects, advantages, and modifications are within the scope of the following claims.

What is claimed is:

1. A hot-melt adhesive composition comprising a non-virgin polymeric material.

2. The hot-melt adhesive composition of claim 1, wherein the non-virgin polymeric material is collected from fabrics, non-woven fabrics, textiles, other fibrous materials, or a combination of any of these.

3. The hot-melt adhesive composition of claim 1, wherein the non-virgin polymeric material has a viscosity of less than about 500,000 cps at a temperature of 190° C.

4. The hot-melt adhesive composition of claim 1, wherein the non-virgin polymeric material has a viscosity from about 100 to 10,000 cps at a temperature of 190° C.

5. The hot-melt adhesive composition of claim 1, wherein the hot-melt adhesive composition has a viscosity from about 5,000 to 150,000 cps at a temperature of 190° C.

6. The hot-melt adhesive composition of claim 1, wherein the non-virgin polymeric material comprises polypropylene.

7. The hot-melt adhesive composition of claim 1, wherein the hot-melt adhesive composition comprises at least about 1% of the non-virgin polymeric material.

8. The hot-melt adhesive composition of claim 7, wherein the hot-melt adhesive composition comprises from about 3 to 10% of the non-virgin polymeric material.

9. The hot-melt adhesive composition of claim 7, wherein the hot-melt adhesive composition comprises from about 5 to 25% of the non-virgin polymeric material.

10. The hot-melt adhesive composition of claim 7, wherein the hot-melt adhesive composition comprises from about 10 to 60% of the non-virgin polymeric material.

11. The hot-melt adhesive composition of claim 1, further comprising a polymer.

12. The hot-melt adhesive composition of claim 11, wherein the polymer comprises amorphous poly alpha olefin (APAO), metallocene polyolefin, ethylene vinyl acetate (EVA), styrene-isoprene-styrene (SIS), poly(styrene-butadiene-styrene) (SBS), styrene-ethylene-butylene-styrene (SEBS), ethylene n-butyl acrylate (ENBA), polybutylene, polypropylene, polyethylene, maleic anhydride (MAH) functionalized polymer, polystyrene, styrene, polyacrylate, acrylic, a combination thereof, or a copolymer thereof.

13. The hot-melt adhesive composition of claim 1, further comprising a resin, an olefin, an additive, an antioxidant, a filler, a wax, or a combination thereof.

14. A hot-melt adhesive composition comprising:
about 3 to 25 wt. % of a non-virgin polymeric material;
about 0 to 50 wt. % of a resin;
about 30 to 95 wt. % of an olefin; and
about 0.1 to 1 wt. % of an antioxidant.

15. The hot-melt adhesive composition of claim 14, wherein the non-virgin polymeric material has a viscosity of less than about 500,000 cps at a temperature of 190° C.

16. The hot-melt adhesive composition of claim 14, wherein the non-virgin polymeric material has a viscosity from about 100 to 10,000 cps at a temperature of 190° C.

17. The hot-melt adhesive composition of claim 14, wherein the hot-melt adhesive composition has a viscosity from about 850 to 150,000 cps at a temperature of 190° C.

18. The hot-melt adhesive composition of claim 14, wherein the non-virgin polymeric material comprises polypropylene.

19. A method of preparing a hot-melt adhesive composition, the method comprising:
obtaining a non-virgin polymeric material having a viscosity of less than about 500,000 cps at a temperature of 190° C.; and
combining the non-virgin polymeric material with a resin, an olefin, an antioxidant, a polymer, a tackifier, an additive, a filler, a wax, or a combination thereof.

20. A hot-melt adhesive composition prepared by the method of claim 19.
